(19) United States
(12) Patent Application Publication
(10) Pub. No.: US 2021/0354913 A1
(43) Pub. Date: Nov. 18, 2021

(54) WASTE COMPRESSION CONTAINER COLLECTION CONTROL SYSTEM AND METHOD

(71) Applicant: ACI CHEMICALS ASIA INC., Seoul (KR)

(72) Inventor: Hyun Soo KIM, Seoul (KR)

(73) Assignee: ACI CHEMICALS ASIA INC., Seoul (KR)

(21) Appl. No.: 16/615,823

(22) PCT Filed: Aug. 9, 2019
(86) PCT No.: PCT/KR2019/010040

§ 371 Date: Nov. 22, 2019

(30) Foreign Application Priority Data
Jan. 3, 2019 (KR) 10-2019-0000663

(51) Int. Cl. B65F 1/14; B65F 3/02

(52) U.S. Cl. CPC B65F 1/1405; B65F 3/02; B65F 2210/184; B65F 2210/128; B65F 2210/162

(57) ABSTRACT

A waste compression container collection control system includes: a waste compression container compressing and accommodating waste input thereto, discarded by users, and transmitting detection information, obtained by at least one sensor, in real time; a collection vehicle driver terminal of a collection vehicle driver of a collection vehicle collecting the waste compression container in which waste is accommodated; and a collection control server receiving at least one piece of detection information from the waste compression container, determining whether or not to collect the waste compression container using the received detection information, automatically assigning a collection vehicle to collect the waste compression container to be collected, and transmitting a collection instruction message to the corresponding collection vehicle driver terminal in real time.

### TECHNICAL FIELD

The present disclosure relates to collection of waste compression containers and, more particularly, to a waste compression container collection control system and method.

### BACKGROUND ART

Household waste, created from domestic dwellings, is generally stored in a single place, from which a collection vehicle collects the stored waste. A waste compression container compresses and accommodates waste, and when the waste compression container is full of waste, a collection vehicle takes the waste compression container away.

Since a large number of waste compression containers are disposed in a number of places of a wide area, it is difficult for a manager to manage the waste compression containers. In particular, the manager may not be able to determine whether or not a waste compression container is full of waste, and it may be difficult to determine when to collect waste compression containers.

An accumulation rate of waste may vary depending on a variety of factors. For example, the accumulation rate of waste may vary depending on the day of a week or the season, or may vary depending on whether a waste compression container is disposed in an urban center or a rural area.

In addition, it is necessary to rapidly collect waste in summer, since the decay rate of waste may be faster in summer, and odor may be created in many cases.

There is demand for a solution for collecting waste by distributing collection vehicles at optimal collection time points in accordance with such a variety of factors.

### DISCLOSURE

### Technical Problem

An objective of the present disclosure is to provide a waste compression container collection control system.

Another objective of the present disclosure is to provide a waste compression container collection control method.

### Technical Solution

A waste compression container collection control system according to a first embodiment of the invention may include: a waste compression container compressing and accommodating waste input thereto, discarded by users, and transmitting detection information, obtained by at least one sensor, in real time; a collection vehicle driver terminal of a collection vehicle driver of a collection vehicle collecting the waste compression container in which waste is accommodated; and a collection control server receiving at least one piece of detection information from the waste compression container, determining whether or not to collect the waste compression container using the received detection information, automatically assigning a collection vehicle to collect the waste compression container to be collected, and transmitting a collection instruction message to the corresponding collection vehicle driver terminal in real time.

Here, the collection vehicle driver terminal may be configured to receive load information regarding whether or not the waste compression container is loaded on the collection vehicle and accommodation information regarding whether or not the loaded waste compression container is empty from the vehicle driver, and to transmit the load information and the accommodation information input thereto to the collection control server.

In addition, the collection control server may be configured to select and match a collection vehicle, on which the waste compression container is not loaded, to the waste compression container, currently requested to be collected, in real time.

In addition, the collection control server may be configured to set orders of priority regarding whether or not to collect the waste compression container in real time, using the detection information received from the waste compression container in real time.

A waste compression container collection control system according to a second embodiment of the invention may include: a waste compression container compressing and accommodating waste input thereto, discarded by users, and transmitting detection information, obtained by at least one sensor, in real time; a collection vehicle mounted terminal mounted on a collection vehicle collecting the waste compression container in which waste is accommodated; and a collection control server receiving at least one piece of detection information from the waste compression container in real time, determining whether or not to collect the waste compression container using the detection information received in real time, automatically selecting a collection vehicle for the waste compression container to be collected, and transmitting a collection instruction message to the corresponding collection vehicle mounted terminal in real time.

Here, the collection vehicle mounted terminal may receive load information and accommodation information from the collection vehicle driver and transmit the load information and the accommodation information to the collection control server in real time.

In addition, the collection control server may be configured to inquire the collection vehicle mounted terminal of whether or not the waste compression container is loaded, and if loaded, whether the waste compression container contains waste or is empty, using the load information and the accommodation information received from the collection vehicle mounted terminal in real time, and according to an inquiry result, to select and match a collection vehicle to the waste compression container in real time.

A waste compression container collection control method according to a first embodiment of the invention may include: compressing and accommodating, by a waste compression container, waste discarded by users and input to the waste compression container; generating, by the waste compression container, detection information using at least one previously-provided sensor, and transmitting the detection information to a collection control server in real time; receiving, by the collection control server, a least one piece of detection information from the waste compression container; determining, by the collection control server, whether or not to collect the waste compression container using the detection information received in real time; automatically selecting and assigning, by the collection control server, a collection vehicle for the waste compression container to be collected; and transmitting, by the collection control server, a collection instruction message to a corresponding collection vehicle driver terminal of the automatically selected and assigned collection vehicle in real time.

Here, the automatically selecting and assigning the collection vehicle for the waste compression container to be collected may include setting orders of priority regarding whether or not to collect the waste compression container in real time, using the detection information received from the waste compression container in real time.

A waste compression container collection control method according to a second embodiment of the invention may include: compressing and accommodating, by a waste compression container, waste discarded by users and input to the waste compression container; generating, by the waste compression container, detection information using at least one previously-provided sensor, and transmitting the detection information to a collection control server in real time; positioning, by a collection vehicle mounted terminal, a collection vehicle and receiving load information and accommodation information; transmitting, by the collection vehicle mounted terminal, the load information and the accommodation information input thereto to the collection control server in real time; receiving, by the collection control server, at least one piece of the detection information from the waste compression container in real time and receiving the load information and the accommodation information from the waste compression container in real time; determining, by the collection control server, whether or not to collect the waste compression container using the detection information received in real time; automatically selecting and assigning, by the collection control server, a collection vehicle for the waste compression container to be collected, using the load information and the accommodation information of the collection vehicles; and transmitting, by the collection control server, a collection instruction message to the collection vehicle mounted terminal in real time.

Here, the automatically selecting and assigning the collection vehicle for the waste compression container to be collected may include: inquiring the collection vehicle mounted terminal of whether or not the waste compression container is loaded, and if loaded, whether the waste compression container contains waste or is empty, using the load information and the accommodation information received from the collection vehicle mounted terminal in real time; and according to an inquiry result, selecting and matching a collection vehicle to the waste compression container in real time.

### Advantageous Effects

The waste compression container collection control system and method as described above are configured to determine whether or not to collect a waste compression container by checking the pressure of a cylinder or considering all of regional characteristics, seasonal characteristics, day of the week, and weather. Accordingly, waste compression containers can be sequentially collected, starting from a waste compression container required to be rapidly collected, so as to be efficiently managed.

In particular, it is possible to calculate estimated increases in waste by big data analysis related to previous collection history, fire history, and the like, and estimate task loads of collection vehicles on the basis of the estimated increases in waste, thereby efficiently distributing collection tasks and estimating collection times.

### DESCRIPTION OF DRAWINGS

FIG. 1 is a conceptual view illustrating the operation of a waste compression container collection control system according to first and second embodiments of the invention;

FIG. 2 is a side cross-sectional view of a waste compression container according to an embodiment of the invention;

FIG. 3 is a block diagram of the waste compression container collection control system according to the first and second embodiments of the invention;

FIG. 4 is a block diagram of a waste compression container according to an embodiment of the invention;

FIG. 5 is a block diagram of the collection vehicle driver terminal according to an embodiment of the invention;

FIG. 6 is a block diagram of the collection vehicle mounted terminal according to an embodiment of the invention;

FIG. 7 is a block diagram of the collection control server according to an embodiment of the invention;

FIG. 8 is a flowchart of a waste compression container collection control method according to the first embodiment of the invention; and

FIG. 9 is a flowchart of the waste compression container collection control method according to the second embodiment of the invention.

### BEST MODE

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims. Similar reference numerals and signs can be used to designate the same or like elements even when they are shown in different accompanying drawings from one another.

Terms, such as “first”, “second”, “A”, and “B” may be used herein to describe a variety of elements, but it should not understood that the elements are limited by these terms. These terms are used merely to distinguish the corresponding element from other elements. For example, a first element may be referred to as a second element without departing from the scope of the invention. Similarly, the second element may be referred to as the first element. The term “and/or” includes any or at least one of mentioned items.

In the case that it is described that a certain structural element “is connected to” or “is in contact with” another structural element, it should be interpreted that another structural element may “be connected to” or “be in contact with” the structural elements as well as that the certain structural element is directly connected to or is in direct contact with another structural element. In contrast, in the case that it is described that a certain structural element “is directly connected to” or “is in direct contact with” another structural element, it should be interpreted that there is no intervening element.

The terms used herein are for the purpose of describing particular embodiments only and are not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the invention will be described in detail with reference to the accompanying drawings.

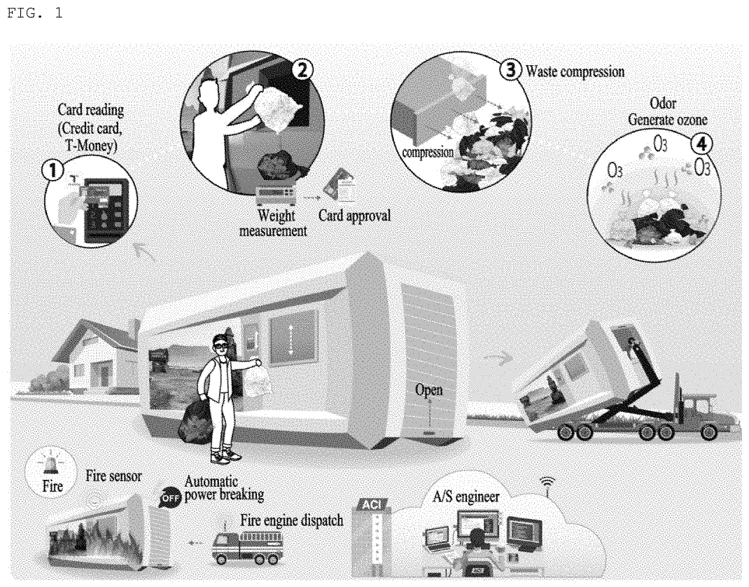

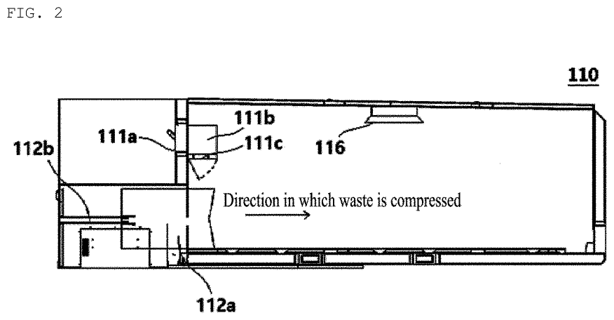

FIG. 1 is a conceptual view illustrating the operation of a waste compression container collection control system according to first and second embodiments of the invention, while FIG. 2 is a side cross-sectional view of a waste compression container according to an embodiment of the invention.

The waste compression container collection control system 100 will be described with reference to FIGS. 1 and 2. A user performs payment using a means of payment, such as a credit card, and a card reader or the like, attached to a waste compression container 110. When the user inputs waste, such as household waste, into the container through a gate, the waste is accommodated in a receptacle. A weight sensor 111c, such as a load cell, is disposed on the top end of the receptacle. The weight of the input waste is measured by the weight sensor 111c. In addition, an amount of money corresponding to the weight is paid. Here, the gate 111a and the receptacle 111b may be provided on a longer side of the waste compression container 110, as illustrated in FIG. 1, or may be provided on a shorter side of the waste compression container 110, as illustrated in FIG. 2. The positions of the gate 111a and the receptacle 111b are not limited.

When the amount of money corresponding to the weight is paid, the waste is delivered from the receptacle to a main space of the waste compression container 110. In the main space, waste is compressed using a ram cylinder 112b in order to increase space utilization.

Since old waste may be generate odor, an ozone generator 116 disposed on the top end of the waste compression container 110 may spray ozone, and odor may be removed by ozone. In addition, in the case that a fire occurs within the waste compression container 110, a fire sensor 115a disposed on the top end of the interior of the waste compression container 110 may detect the fire. When a fire is detected, the supply of power is automatically stopped by a power breaker 115b.

Fire detection information is automatically transmitted to a collection control server 130 in real time. The collection control server 130 is configured to receive the fire detection information and automatically report a fire to a fire station. The collection control server 130 may be configured to provide information indicating a fire and information regarding the position to the fire station when reporting the fire to the fire station.

In addition, it may be configured to determine whether or not the waste compression container 110 is full of waste using information regarding a total amount of waste input to the waste compression container 110 and information regarding an amount of electric current loaded on a hydraulic drive motor providing pressure to the ram cylinder 112b.

The collection control server 130 may determine whether or not to collect waste and a collection time point of waste, on the basis of the weight detection information, the current load information, and the like. The determination of the collection time point may be performed to estimate the collection time point in advance by calculating statistics related to points in time of accumulation, a period of accumulation, a rate of accumulation, and the like. A collection instruction may be sent before about one (1) week or less by estimating the collection time point.

In addition, in FIG. 2, the waste compression container 110 may have a hexahedral shape, and may be sized such that a single waste compression container can be loaded on a container truck.

The waste compression container 110 may be disposed in an apartment complex, a housing complex, or the like, such that waste discarded from a number of houses can be dumped into the waste compression container 110 through the gate 111.

Waste, accommodated after having passed through the gate 111, is pressed by a compression ram 112 driven by the hydraulically-actuated ram cylinder 112b. Waste may be compressed by pressure in order to provide as large an accommodation space as possible.

When there is a waste compression container 110 from which waste has to be collected, a waste collection vehicle may replace the waste compression container 110 full of waste with an empty waste compression container 110 and carry the waste compression container 110 full of waste to a disposal site, at which the waste compression container 110 full of waste is emptied.

In addition, an empty waste compression container 110 may be carried to and disposed in a place in which waste collection is required, and a waste compression container 110, required to be collected, may be connected and carried to the disposal site.

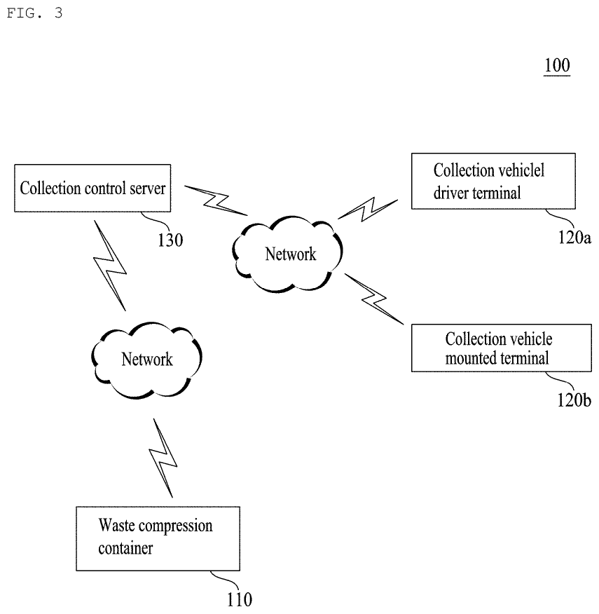

FIG. 3 is a block diagram of the waste compression container collection control system according to the first and second embodiments of the invention.

Referring to FIG. 3, the waste compression container collection control system 100 according to the first and second embodiments of the invention may include the waste compression container 110, a collection vehicle driver terminal 120a, a collection vehicle mounted terminal 120b, and the collection control server 130.

The waste compression container collection control system 100 may be configured to determine the collection time point of the waste compression container 110 in real time, in consideration of regional characteristics, seasonal characteristics, day of the week, weather, previous collection history, and the like.

It is possible to prevent overloading of the waste compression container 110 and reduce odor by correctly determining the collection time point and instructing the waste compression container 110 to be properly collected at a proper time.

Here, the collection vehicle driver terminal 120a and the collection vehicle mounted terminal 120b are components performing similar functions, and may provide the first embodiment and the second embodiment of the invention.

Hereinafter, specific configurations will be described.

The waste compression container 110 is a component which may be disposed in a plurality of places, such as an apartment complex, a housing complex, and an industrial complex, and may be configured to accommodate waste discarded by residents or factory workers.

The waste compression container 110 may be configured to compress waste to reduce the volume of waste and accommodate a greater amount of waste.

The waste compression container 110 may be configured to generate detection information using at least one preinstalled sensor and to transmit the detection information to the collection control server 130 in real time. The detection information may be detection information regarding a cylinder compression pressure, detection information regarding whether or not a fire has occurred, and the like.

The waste compression container 110 may be configured to generate detection information using at least one preinstalled sensor and to transmit the detection information to the collection control server 130 in real time.

The waste compression container 110 may be implemented as a variety of product embodiments.

The waste compression container 110 may be configured to start measuring the weight of waste, basically using a credit card or a T-money card, charge an amount of money corresponding to the measured weight of waste, and maximize a loading amount by compressing waste. In addition, the waste compression container 110 may be configured to spray ozone thereinto to reduce odor. The waste compression container 110 may be configured to be collected when 80% of the maximum capacity is full.

According to an embodiment of the waste compression container 110, the waste compression container 110 may be configured to shred waste while compressing waste. After shredding, waste may be stored at a relatively-low temperature of about 10° C. to reduce odor.

According to another embodiment of the waste compression container 110, the waste compression container 110 may be configured to recognize the face of a person discarding waste. Previously issued bar codes or quick response (QR) codes may be attached to waste to be input into the container. Bar codes or QR codes may be used to examine whether or not non-coded waste is input, mixed with waste to which bar codes or QR codes are attached. If a user discharges coded waste mixed with non-coded waste, future discharges by the user may be restricted.

In addition, a loading amount sensor may be attached to the top end of the waste receptacle of the waste compression container 110. The loading amount sensor may be used to reduce and optimize the line of flow of the waste collection vehicle by detecting a loading amount, and may be configured to detect overturning of the container or a fire in the container.

In addition, according to another embodiment of the waste compression container 110, the waste compression container 110 may be implemented as a storage apparatus. If the waste collection space on the ground is not enough, the waste compression container may be configured to be disposed underground, thereby advantageously minimizing odor and dust and reducing the occupation of space.

In addition, according to another embodiment of the waste compression container 110, the waste compression container 110 may be configured such that photovoltaic cell panels are attached thereto. Power generated by the photovoltaic cell panels may be used to transmit information regarding a loading amount, information regarding a fire, and the like, of the waste compression container 110 through a wireless communications network or refrigerate waste.

In addition, the waste compression container 110 may be configured to review and transmit an amount of collection, a total amount of fees, regional amounts of waste, regional waste trend information, equipment status, and the like, in real time, via the wireless communications network. In addition, a collection vehicle driver or an after service (AS) mechanic may check corresponding matters in real time using a mobile terminal.

The collection vehicle driver terminal 120a is a terminal carried by the collection vehicle driver, and may be a smartphone, a tablet personal computer (PC), or the like.

The collection vehicle driver terminal 120a may be configured to position the collection vehicle on the road or the collection vehicle currently in operation in real time.

The collection vehicle driver terminal 120a may be configured to transmit position information of the collection vehicle, obtained by the real-time measurement, to the collection control server 130 in real time.

The collection vehicle may have the collection vehicle mounted terminal 120b, separately mounted thereon, instead of the collection vehicle driver terminal 120a.

The collection vehicle mounted terminal 120b may be configured to position the collection vehicle on the road or the collection vehicle currently in operation in real time.

The collection vehicle mounted terminal 120b may be configured to transmit position information of the collection vehicle, obtained by the real-time measurement, to the collection control server 130 in real time.

The collection vehicle mounted terminal 120b may be configured to transmit position information of the collection vehicle, obtained by the real-time measurement, to the collection control server 130 in real time.

In addition, the collection vehicle mounted terminal 120b may be configured to have load information and accommodation information input thereto. The load information refers to information regarding whether or not the waste compression container 110 is full. The accommodation information is information regarding whether the waste compression container 110 is empty or full when the waste compression container 110 is loaded.

The collection vehicle mounted terminal 120b may recognize the load information and the accommodation information in accordance with the weight information, and may be configured to transmit the load information and the accommodation information, recognized as above, to the collection control server 130 in real time.

The collection control server 130 may be configured to receive at least one piece of detection information from the waste compression container 110 in real time. In addition, the collection control server 130 may be configured to receive the position information, the load information, and the accommodation information of the collection vehicle from the collection vehicle driver terminal 120a or the collection vehicle mounted terminal 120b in real time.

The collection control server 130 may be configured to estimate, decide, and determine whether or not to collect the waste compression container 110 using information received in real time, including the detection information, the load information, and the accommodation information, previous collection history from a place in which the corresponding waste compression container 110 is disposed, and big data analysis based on the previous collection history.

Here, the collection control server 130 may be configured to determine the orders of priority regarding the collection of the waste compression container 110 by combining the detection information, the previous collection history, and the big data analysis based on the previous collection history.

More specifically, the collection control server 130 may be configured to review the load information and the accommodation information regarding the collection vehicle on the road. In addition, the collection control server 130 may be configured to determine the orders of priority regarding the collection of the waste compression containers 110. In addition, the collection control server 130 may be configured to match a closest non-loaded collection vehicle or a collection vehicle loaded with an empty waste compression container 110 to the waste compression containers 110 according to the orders of priority in real-time.

The collection control server 130 may be configured to perform real-time matching by selecting one collection vehicle closest to the waste compression container 110 currently requested to be collected from among collection vehicles, which are traveling on the road and on each of which no waste compression container 110 is loaded, and matching the selected collection vehicle to the waste compression container 110.

Regarding the collection of the waste compression container 110 to be collected, the collection control server 130 may be configured to automatically select one collection vehicle from among collection vehicles traveling on the road and transmit a collection instruction message to the corresponding collection vehicle driver terminal 120a or collection vehicle mounted terminal 120b in real time.

The collection instruction message may include the position information of the corresponding waste compression container 110. The collection vehicle driver terminal 120a or the collection vehicle mounted terminal 120b may be configured to guide a route on the basis of the corresponding position information by applying the corresponding position information to a navigation application.

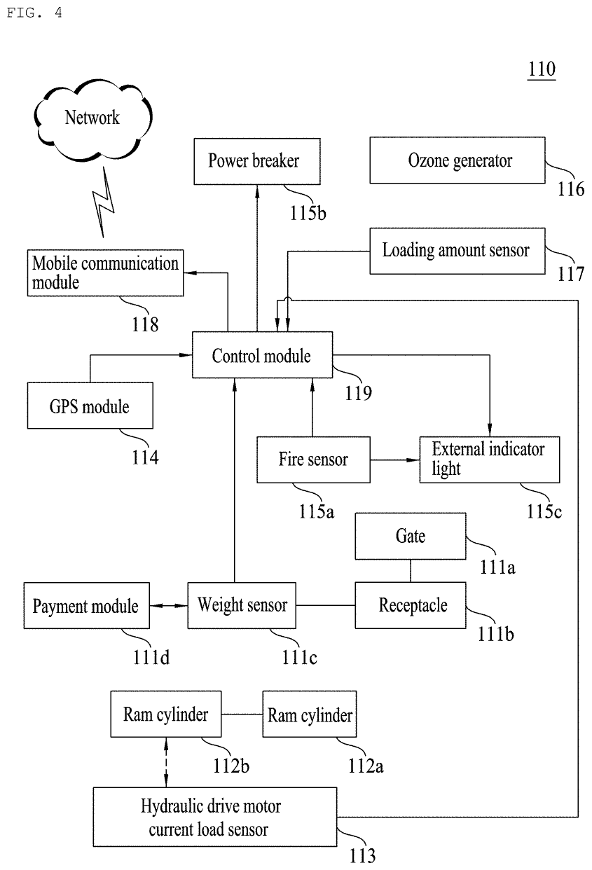

FIG. 4 is a block diagram of a waste compression container according to an embodiment of the invention.

Referring to FIG. 4, the waste compression container 110 according to an embodiment of the invention may be configured to include a gate 111a, a receptacle 111b, a weight sensor 111c, a payment module 111d, a compression ram 112a, a ram cylinder 112b, a hydraulic drive motor current loading amount sensor 113, a global positioning system (GPS) module 114, a fire sensor 115a, a power breaker 115b, an external indicator light 115c, an ozone generator 116, a loading amount sensor 117, a mobile communication module 118, and a control module 119.

Hereinafter, specific configurations will be described.

The gate 111a is an opening through which waste is input.

The receptacle 111b is a space in which waste, input through the gate 111a, is temporarily stored.

The weight sensor 111c, such as a load cell, may be disposed on the top end of the receptacle 111b. The weight sensor 111c may be configured to measure the weight of waste accommodated in the receptacle 111b.

The payment module 111d may be configured to charge an amount of money, corresponding to the weight of waste measured by the weight sensor 111c, using a means of payment, such as a credit card.

The compression ram 112a may be configured to perform piston movement along a shaft, in response to the ram cylinder 112b being driven by a hydraulic drive unit (not shown) to perform axial movement. Waste may be compressed by the compression ram 112a, so that the volume of waste may be reduced. Accordingly, a space for accommodating a greater amount of waste can be obtained. The hydraulic driving may be performed after waste, accommodated in the receptacle 111b, is input to the main space after the payment is completed by the payment module 111d.

The hydraulic drive motor current loading amount sensor 113 is mounted on a motor driving a hydraulic apparatus. Hydraulic oil is supplies to a press ram cylinder, driven by the hydraulic apparatus, to have compressive force. Accordingly, it is possible to reduce the volume of waste. If a greater amount of waste is to be compressed, the pressure of hydraulic oil applied to the ram cylinder should be increased, thereby increasing the amount of current of the electric drive motor. If a smaller amount of waste is to be compressed, the amount of current of the electric drive motor is reduced.

The hydraulic drive motor current loading amount sensor 113 may measure an amount of current input to the electric motor of the hydraulic apparatus to determine the load of the waste compression container 110.

In addition, it is possible to determine the load of the waste compression container 110, on the basis of a cumulative value of weights measured by the weight sensor 111c.

The control module 119 may be configured to calculate the cumulative value of weights and obtain a pressure value of the pressure sensor 114 in real time. The control module 119 may be configured to estimate the load of the waste compression container 110 by combining the cumulative value and the input value.

The GPS module 114 may be configured to position the waste compression container 110. The collection control server 130 can locate the place in which the waste compression container 110 is disposed and locate the waste compression container 110 in real time.

The fire sensor 115a may be configured to detect whether or not the waste compression container 110 has a fire in real time. The fire sensor 115a may be disposed on the top end of the interior of the waste compression container 110 to detect an internal temperature.

The control module 119 may be configured to report a fire to the collection control server 130 and to take an action in the event of a fire.

The control module 119 may be configured to, first, turn on the external indicator light 115c, disposed on the outer portion of the waste compression container 110 to alert a fire.

In addition, the control module 119 may be configured to interrupt power supplied to the waste compression container 110 by operating the power breaker 115b. The control module 119 may be configured to prevent greater damage caused by the fire by interrupting the supply of power.

Here, the external indicator light 115c may be configured to indicate whether or not the waste compression container 110 is overloaded, i.e. the waste compression container 110 should be collected, whether or not a fire has occurred within the waste compression container 110, or the like, so that persons outside of the container can visually recognize the overloading, the occurrence of a fire, or the like.

In addition, the ozone generator 116 may be configured to remove odor created by extended storage of waste. The ozone generator 116 may be provided on the top end of the interior of the waste compression container 110.

The loading amount sensor 117 may be configured to detect an amount of waste loaded (or loading amount) in the compression container 110. The loading amount sensor 117 may perform the detection by measuring the weight of the loading amount using a load cell or by measuring the height of the load using a laser sensor disposed on the top surface of the interior.

Even in the case in which the loading amount sensor 117 is not used, the loading amount may be calculated by accumulating weights measured by the weight sensor 111c whenever waste is input.

The mobile communication module 118 may be configured to transmit current load information measured by the hydraulic drive motor current loading amount sensor 113, position information of the GPS module 114, fire information obtained by the fire sensor 115a, a loading amount detected by the loading amount sensor 117, cumulative weight value information cumulatively measured by the weight sensor 111c, and the like, to the collection control server 130.

The control module 119 may be configured to automatically control the above-described operations of the gate 111a, the receptacle 111b, the weight sensor 111c, the payment module 111d, the compression ram 112a, the ram cylinder 112b, the hydraulic drive motor current loading amount sensor 113, the GPS module 114, the fire sensor 115a, the power breaker 115b, the external indicator light 115c, the ozone generator 116, the loading amount sensor 117, the mobile communication module 118, and the like.

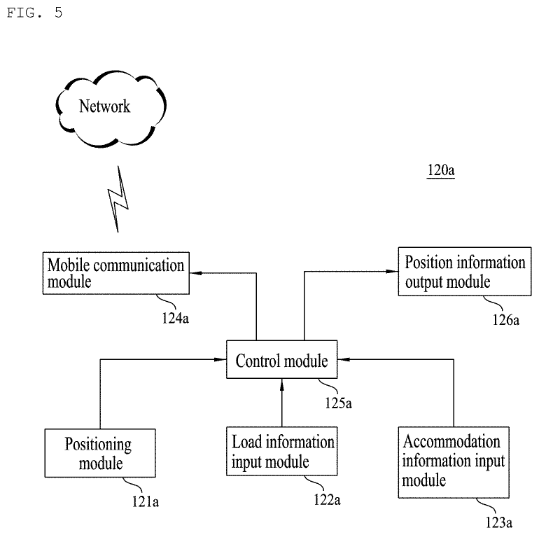

FIG. 5 is a block diagram of the collection vehicle driver terminal according to an embodiment of the invention.

Referring to FIG. 5, the collection vehicle driver terminal 120a includes a positioning module 121a, a load information input module 122a, an accommodation information input module 123a, a mobile communication module 124a, a control module 125a, and a position information output module 126a.

Hereinafter, specific configurations will be described.

The positioning module 121a may be configured to measure the current position of the collection vehicle in real time. The positioning module 121a may be configured to measure an accurate position by combining a WiFi method, a hybrid method, and the like.

The load information input module 122a may be configured to have information regarding whether or not a collection vehicle, on which the load information input module 122a is disposed, is loaded with the waste compression container 110. The information is input by the collection vehicle driver. The collection vehicle driver terminal 120a may be configured to receive load information by a touch input on an application of the collection vehicle driver terminal 120a.

Here, the collection vehicle may be a vehicle parked in a collection vehicle-dedicated parking lot or a vehicle traveling on the road.

The accommodation information input module 123a may be configured to receive accommodation information indicating whether the waste compression container 110, currently loaded on the collection vehicle, is full of waste or empty. The accommodation information input module 123a may be configured to receive the accommodation information by a touch input on the application of the collection vehicle driver terminal 120a.

The mobile communication module 124a may be configured to transmit the position information measured by the positioning module 121a, the load information input from the load information input module 122a, and the accommodation information input from the accommodation information input module 123a to the collection control server 130 in real time, under the control of the control module 125a.

In addition, the mobile communication module 124a may be configured to receive the collection instruction message from the collection control server 130.

The control module 125a may be configured to control the operations of the positioning module 121a, the load information input module 122a, the accommodation information input module 123a, the mobile communication module 124a, and the position information output module 126a.

The position information output module 126a may be configured to parse the collection instruction message, which the mobile communication module 124a has received from the collection control server 130, to output the position information of a place in which the waste compression container 110, to be collected, is disposed.

The position information of the place in which the waste compression container 110, to be collected, is disposed may be two or more pieces of information, and the orders of priority thereof may have been determined in advance.

The position information, output from the position information output module 126a, may be automatically input to the navigation application of the collection vehicle driver terminal 120a according to the orders of priority, so as to guide a route of the collection vehicle.

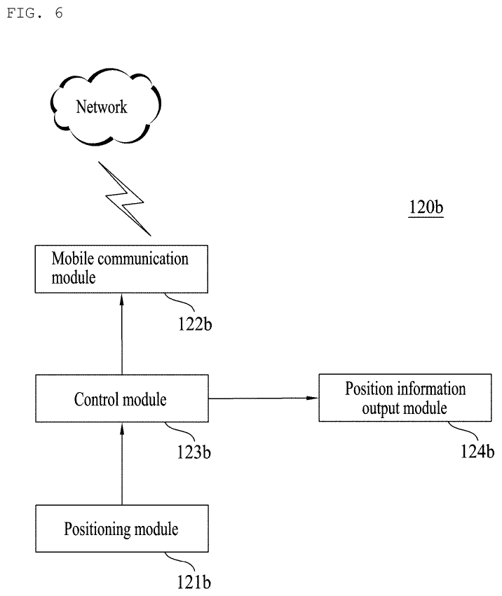

FIG. 6 is a block diagram of the collection vehicle mounted terminal according to an embodiment of the invention.

Referring to FIG. 6, the collection vehicle mounted terminal 120b according to an embodiment of the invention may be configured to include a positioning module 121b, a mobile communication module 122b, a control module 123b, and a position information output module 124b.

Hereinafter, specific configurations will be described.

The positioning module 121b may be configured to measure the current position of the collection vehicle. The positioning module 121b may be configured to measure an accurate position by combining a WiFi method, a hybrid method, and the like. Here, the collection vehicle may be a vehicle parked in a collection vehicle-dedicated parking lot or a vehicle traveling on the road.

The mobile communication module 122b may be configured to transmit the current position of the collection vehicle, measured by the positioning module 121b, to the collection control server 130 in real time, and to transmit the load information and the accommodation information to the collection control server 130. In addition, the mobile communication module 122b may be configured to receive the collection instruction message from the collection control server 130.

The control module 123b may be configured to control the operations of the positioning module 121b, the mobile communication module 122b, and the position information output module 124b in real time.

In addition, the control module 123b may be configured to receive the load information and the accommodation information from the collection vehicle driver via a touchscreen (not shown) and transmit the load information and the accommodation information to the collection control server 130 via the mobile communication module 122b. The load information is information indicating whether or not the waste compression container 110 is loaded on the collection vehicle, while the accommodation information is information indicating whether the waste compression container 110 is full of waste or empty.

Thus, the control module 123b may be configured to generate information regarding a loaded state and an accommodation state and transmit the generated information to the collection control server 130 via the mobile communication module 122b.

The position information output module 124b may be configured to parse the collection instruction message, which the mobile communication module 122b has received from the collection control server 130, to output the position information of a place in which the waste compression container 110, to be collected, is disposed.

The position information of the place in which the waste compression container 110, to be collected, is disposed may be two or more pieces of information, and the orders of priority thereof may have been determined in advance.

The position information, output from the position information output module 124b, may be automatically input to the navigation application of the collection vehicle driver terminal 120b according to the orders of priority, so as to guide a route of the collection vehicle.

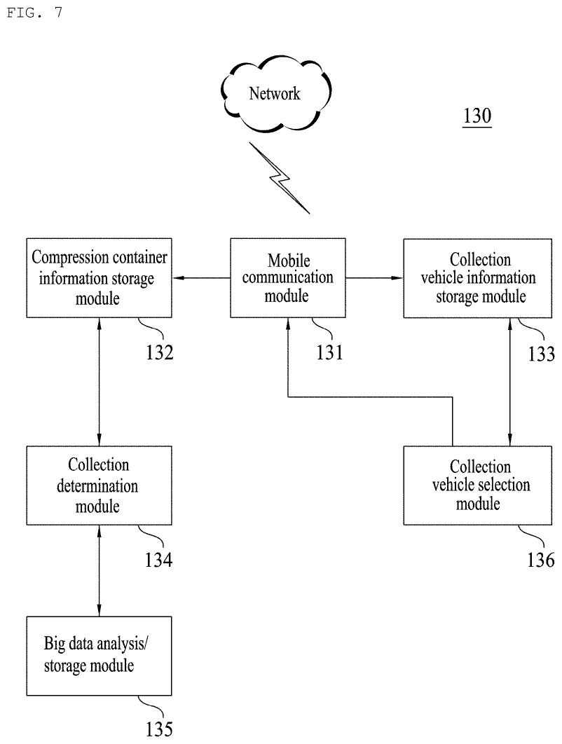

FIG. 7 is a block diagram of the collection control server according to an embodiment of the invention.

Referring to FIG. 7, the collection control server 130 according to an embodiment of the invention may be configured to include a mobile communication module 131, a compression container information storage module 132, a collection vehicle information storage module 133, a collection determination module 134, a big data analysis/storage module 135, and a collection vehicle selection module 136.

Hereinafter, specific configurations will be described.

The mobile communication module 131 may be configured to receive the detection information, such as compression information and detection information, and the position information of the waste compression container 110 from the collection vehicle driver terminal 120a or the collection vehicle mounted terminal 120b in real time.

In addition, the mobile communication module 131 may be configured to receive the load information and the accommodation information from the collection vehicle mounted terminal 120b in real time.

In addition, the mobile communication module 131 may be configured to receive information regarding a loading amount, detected by the loading amount sensor 117, or information regarding a cumulative weight value, cumulatively measured by the weight sensor 111c, from the waste compression container 110.

The compression container information storage module 132 may be configured to store the position information, loading amount information, cumulative weight information, pressure information, collection necessity information, load information, and accommodation information of the waste compression containers 110, received from the mobile communication module 131.

The collection vehicle information storage module 133 may be configured to store the current position information of the collection vehicle received from the mobile communication module 131.

The collection determination module 134 may be configured to re-determine whether or not to collect the waste compression containers 110 using the position information, loading amount information, cumulative weight information, pressure information, collection necessity information, load information, and accommodation information of the waste compression containers 110, stored in the compression container information storage module 132, and determine orders of priority. For example, if the loading amount of the waste compression container 110 or the cumulative value information is about 80% of the maximum capacity, it may be determined that the waste compression container should be collected. Accordingly, it is possible to prevent the waste compression container 110 from being overloaded with waste, and optimal selective collection is possible.

In addition, whether or not to collect may be determined by additionally considering the big data analysis result analyzed by the big data analysis/storage module 135. Determination of whether or not to collect the container may be performed by determining the orders of priority of objects to be collected.

Here, the big data analysis/storage module 135 may be configured to analyze the accumulation rate of waste or estimated increases in waste in the waste compression containers 110, using collection history data of the places in which the containers are disposed, according to the region, day of a week, season, weather, and time. For example, the big data analysis may be performed, on the basis of the fact that amounts of waste accumulated according to the region are increased in summer or in a specific day of a week. In addition, since the decay rate of waste in summer is faster, collection should be performed even if the amount of accumulated waste is less than 50%. In this manner, analysis can be performed on the basis of a wide range of data. In particular, in a rural area, the amount of accumulated waste increases at a low rate, i.e. waste is accumulated at a low rate. Thus, in summer, collection should be performed even if the container is not full of waste. That is, in summer, a replacement time limit for collection may be set in consideration of decay.

The collection determination module 134 may be configured to determine the waste compression container 110 to be collected, according to the following conditions to be considered.

First, as the first condition to be considered, the object to be collected may be selected using a loading amount, a cumulative weight value, or a pressure value, and the orders of priority may be determined. Here, a waste container having a value corresponding to 80% of a predetermined maximum amount of burden may be selected to be an object to be collected. The greater the amount of waste accumulated is, the higher the order of priority may be assigned. If all of the loading amount, the cumulative weight value, and the current load exceed 80% of a maximum load, a highest order of priority may be assigned. If one of the loading amount, the cumulative weight value, and the current load exceeds 80% or more of a maximum load, a next highest order of priority may be assigned. In addition, the higher the percentage of the load is, the higher the order of priority to be assigned may be.

As a next condition to be considered, in accordance with the big data analysis, replacement time limits may be set in summer and winter. In summer in which the decay rate of waste is relatively fast, a container may be selected to be collected in one month even if a smaller amount of waste has been accumulated. In contrast, in winter in which the decay rate of waste is relatively slow, a container may be selected to be collected in two months even if a smaller amount of waste has been accumulated.

As a next condition to be considered, it may be possible to select objects to be collected by estimating real-time increases in the amount of waste accumulated according to the region, season, day of a week, and weather, on the basis of the big data analysis.

As a next condition to be considered, when a fire has occurred, a container disposed in the place in which the fire has occurred may be selected to be collected first. The server may be automatically connected to a fire station, and after the fire is extinguished, the container may be collected.

The collection vehicle selection module 136 may be configured to match one of the collection vehicles to the waste compression container 110 selected to be collected, in real time, using information regarding whether or not to collect the waste compression containers 110, determined by the collection determination module 134, and current position information of the collection vehicles currently parked or traveling, stored in the collection vehicle information storage module 133.

Here, the collection vehicle selection module 136 may be configured to select the collection vehicle according to the order of priority of the object to be collected. The collection vehicle selection module 136 may be configured to select a collection vehicle closest to an object having the highest order of priority to be collected and instruct the collection vehicle to collect the object. Here, the collection instruction message may be transmitted to the collection vehicle via the mobile communication module 131. In this manner, a collection vehicle closest to an object having the next highest order of priority to be collected may be selected and instructed to collect the object. The above-described algorithm can optimize the line of flow of the collection vehicle, thereby improving the efficiency of collection.

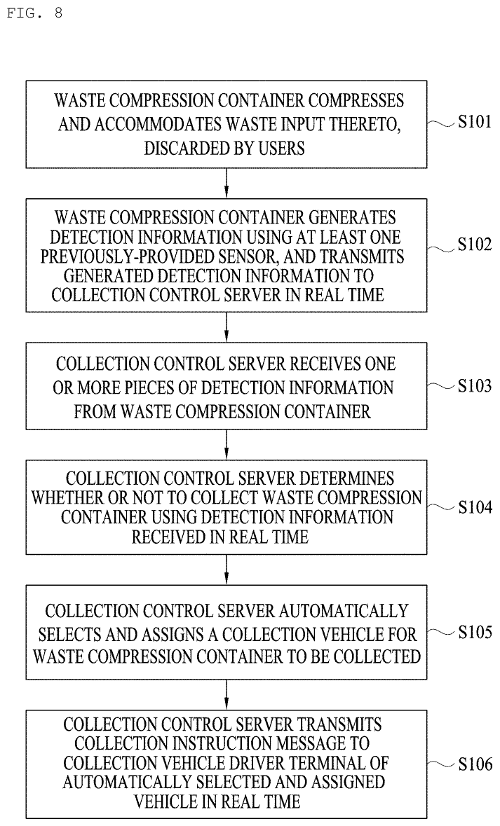

FIG. 8 is a flowchart of a waste compression container collection control method according to the first embodiment of the invention.

Referring to FIG. 8, the waste compression container 110 compresses and accommodates waste input thereto, discarded by users (S101).

Afterwards, the waste compression container 110 generates detection information using at least one previously-provided sensor, and transmits the generated detection information to the collection control server 130 in real time (S102).

Subsequently, the collection control server 130 receives one or more pieces of detection information from the waste compression container 110 (S103).

Afterwards, the collection control server 130 determines whether or not to collect the waste compression container 110 using the detection information received in real time (S104).

Subsequently, the collection control server 130 automatically selects and assigns a collection vehicle for the waste compression container 110 to be collected (S105).

In addition, orders of priority regarding whether or not to collect may be set in real time using the detection information received from the waste compression container 110 in real time.

Afterwards, a collection instruction message is transmitted to the corresponding collection vehicle driver terminal 120a of the collection vehicle, automatically selected and assigned by the collection control server 130, in real time (S106).

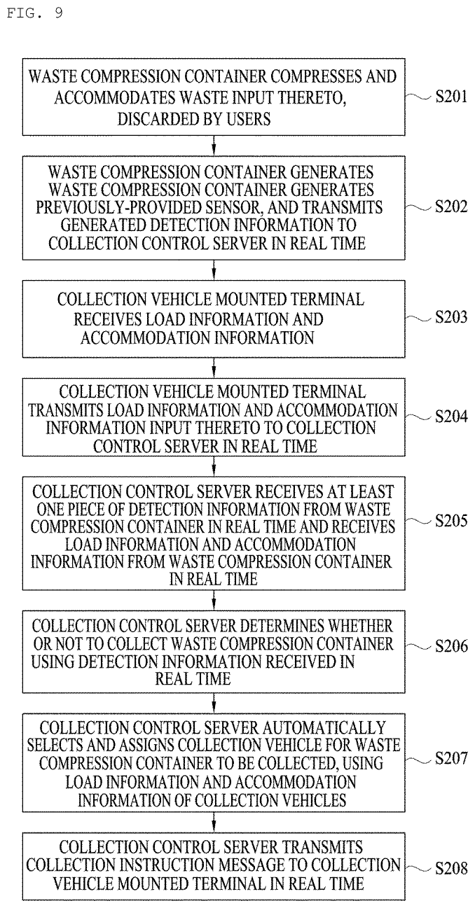

FIG. 9 is a flowchart of the waste compression container collection control method according to the second embodiment of the invention.

Referring to FIG. 9, first, the waste compression container 110 compresses and accommodates waste input thereto, discarded by users (S201).

Afterwards, the waste compression container 110 generates detection information using at least one previously-provided sensor, and transmits the generated detection information to in real time (S202).

Subsequently, the collection vehicle mounted terminal 120b receives load information and accommodation information (S203).

Afterwards, the collection vehicle mounted terminal 120b transmits the load information and the accommodation information, input thereto, to the collection control server 130 in real time (S204).

Subsequently, the collection control server 130 receives at least one piece of the detection information from the waste compression container 110 in real time and receives the load information and the accommodation information from the waste compression container 110 in real time (S205).

Afterwards, the collection control server 130 determines whether or not to collect the waste compression container 110 using the detection information received in real time (S206).

Subsequently, the collection control server 130 automatically selects and assigns a collection vehicle for the waste compression container 110 to be collected, using the load information and the accommodation information of the collection vehicles (S207).

Here, the collection control server 130 may be configured to inquire the collection vehicle mounted terminal 120b of whether or not the waste compression container 110 is loaded, and if loaded, whether the waste compression container 110 contains waste or is empty, using the load information and the accommodation information received from the collection vehicle mounted terminal 120b in real time. According to a result of the inquiry, a collection vehicle may be selected and matched to the waste compression container 110 in real time.

Afterwards, the collection control server 130 transmits a collection instruction message to the collection vehicle mounted terminal 120b in real time (S208).

Although the embodiments of the present invention have been described for illustrative purposes, those skilled in the art will appreciate that various modifications and alterations are possible, without departing from the scope and spirit of the present invention as disclosed in the accompanying claims.

1. A waste compression container collection control system comprising:
a waste compression container compressing and accommodating waste input thereto, discarded by users, and transmitting detection information, obtained by at least one sensor, in real time;
a collection vehicle driver terminal of a collection vehicle driver of a collection vehicle collecting the waste compression container in which waste is accommodated; and
a collection control server receiving at least one piece of detection information from the waste compression container, determining whether or not to collect the waste compression container using the received detection information, automatically assigning a collection vehicle to collect the waste compression container to be collected, and transmitting a collection instruction message to the corresponding collection vehicle driver terminal in real time.

2. The waste compression container collection control system according to claim 1, wherein the collection vehicle driver terminal is configured to receive load information regarding whether or not the waste compression container is loaded on the collection vehicle and accommodation information regarding whether or not the loaded waste compression container is empty from the vehicle driver, and to transmit the load information and the accommodation information input thereto to the collection control server.

3. The waste compression container collection control system according to claim 2, wherein the collection control server is configured to select and match a collection vehicle, on which the waste compression container is not loaded, to the waste compression container, currently requested to be collected, in real time.

4. The waste compression container collection control system according to claim 1, wherein the collection control server is configured to set orders of priority regarding whether or not to collect the waste compression container in real time, using the detection information received from the waste compression container in real time.

5. The waste compression container collection control system according to claim 1, further comprising:
a collection vehicle mounted terminal mounted on a collection vehicle collecting the waste compression container in which waste is accommodated,
wherein the collection control server receiving at least one piece of detection information from the waste compression container in real time, determining whether or not to collect the waste compression container using the detection information received in real time, automatically selecting a collection vehicle for the waste compression container to be collected, and transmitting a collection instruction message to the corresponding collection vehicle mounted terminal in real time.

6. The waste compression container collection control system according to claim 5, wherein the collection vehicle mounted terminal receives load information and accommodation information from the collection vehicle driver and transmits the load information and the accommodation information to the collection control server in real time, and
the collection control server is configured to inquire the collection vehicle mounted terminal of whether or not the waste compression container is loaded, and if loaded, whether the waste compression container contains waste or is empty, using the load information and the accommodation information received from the collection vehicle mounted terminal in real time, and according to an inquiry result, to select and match a collection vehicle to the waste compression container in real time.

7. A waste compression container collection control method comprising:
compressing and accommodating, by a waste compression container, waste discarded by users and input to the waste compression container;
generating, by the waste compression container, detection information using at least one previously-provided sensor, and transmitting the detection information to a collection control server in real time;
receiving, by the collection control server, a least one piece of detection information from the waste compression container;
determining, by the collection control server, whether or not to collect the waste compression container using the detection information received in real time;
automatically selecting and assigning, by the collection control server, a collection vehicle for the waste compression container to be collected; and
transmitting, by the collection control server, a collection instruction message to a corresponding collection vehicle driver terminal of the automatically selected and assigned collection vehicle in real time.

8. The waste compression container collection control method according to claim 7, wherein the automatically selecting and assigning the collection vehicle for the waste compression container to be collected comprises setting orders of priority regarding whether or not to collect the waste compression container in real time, using the detection information received from the waste compression container in real time.

9. A waste compression container collection control method comprising:
compressing and accommodating, by a waste compression container, waste discarded by users and input to the waste compression container;
generating, by the waste compression container, detection information using at least one previously-provided sensor, and transmitting the detection information to a collection control server in real time;
positioning, by a collection vehicle mounted terminal, a collection vehicle and receiving load information and accommodation information;
transmitting, by the collection vehicle mounted terminal, the load information and the accommodation information input thereto to the collection control server in real time;
receiving, by the collection control server, at least one piece of the detection information from the waste compression container in real time and receiving the load information and the accommodation information from the waste compression container in real time;
determining, by the collection control server, whether or not to collect the waste compression container using the detection information received in real time;
automatically selecting and assigning, by the collection control server, a collection vehicle for the waste compression container to be collected, using the load information and the accommodation information of the collection vehicles; and
transmitting, by the collection control server, a collection instruction message to the collection vehicle mounted terminal in real time.

10. The waste compression container collection control method according to claim 9, wherein the automatically selecting and assigning the collection vehicle for the waste compression container to be collected comprises:
inquiring the collection vehicle mounted terminal of whether or not the waste compression container is loaded, and if loaded, whether the waste compression container contains waste or is empty, using the load information and the accommodation information received from the collection vehicle mounted terminal in real time; and according to an inquiry result, selecting and matching a collection vehicle to the waste compression container in real time.
